(19) United States
(12) Patent Application Publication
(10) Pub. No.: US 2024/0396045 A1
(43) Pub. Date: Nov. 28, 2024

(54) LITHIUM-ION SECONDARY BATTERY

(71) Applicant: TDK Corporation, Tokyo (JP)

(72) Inventors: Takashi MOURI, Tokyo (JP); Rie IHARA, Tokyo (JP)

(73) Assignee: TDK Corporation, Tokyo (JP)

(21) Appl. No.: 18/201,197

(22) Filed: May 24, 2023

(51) Int. Cl. H01M 4/62; H01M 4/134; H01M 4/38; H01M 10/0525

(52) U.S. Cl. CPC H01M 4/622; H01M 4/134; H01M 4/386; H01M 10/0525; H01M 2004/027

(57) ABSTRACT

This lithium-ion secondary battery may have a positive electrode, a negative electrode, a separator present between the positive electrode and the negative electrode and an electrolytic solution. The negative electrode may contain silicon or a silicon compound and a binder, and the binder may contain polyimide. When the negative electrode after discharging is observed by nuclear magnetic resonance (NMR) spectroscopy using a single-pulse magic-angle spinning method (SP-MAS method) and peaks are separated by a Gaussian function, a Lorentzian function or a Voigt function, an NMR spectrum of a solid⁷ Li nucleus may have a first peak, and the first peak may have a peak top in a chemical shift range of 0.5 ppm or more and 1.5 ppm or less with Li in LiCoO₂ set to −0.5 ppm.

### BACKGROUND

### Technical Field

The present disclosure relates to a lithium-ion secondary battery.

### Description of Related Art

Lithium-ion secondary batteries are also in wide use as power sources for mobile devices such as mobile phones and laptop computers, hybrid vehicles or the like.

The capacity of a lithium-ion secondary battery mainly depends on an active material in an electrode. As a negative electrode active material, graphite is ordinarily used, but there is a demand for a negative electrode active material having a higher capacity. Therefore, attention is paid to silicon (Si) having a significantly large theoretical capacity compared with the theoretical capacity of graphite (372 mAh/g).

Charging of a negative electrode active material containing Si involves large volume expansion. Volume expansion of a negative electrode active material causes deterioration of the cycle characteristics of batteries. When the volume of a negative electrode active material expands, for example, a conduction path between the particles of the negative electrode active material is cut, exfoliation occurs in the interface between the negative electrode active material and a current collector, or cracks are generated in a solid electrolyte interphase (SEI) film and an electrolytic solution decomposes or the like. These degrade the cycle characteristics of batteries.

In order to improve the cycle characteristics of batteries, a binder is used in negative electrode active material layers. For example, Patent Document 1 discloses a lithium-ion secondary battery in which polyimide is used as a binder.

### Patent Documents

[Patent Document 1] Japanese Unexamined Patent Application, First Publication No. 2007-242405

### SUMMARY OF THE DISCLOSURE

There is a demand for additional improvement in cycle characteristics.

Some embodiments of the present disclosure have been made in consideration of the above-described problems, and an objective of the present disclosure is to provide a lithium-ion secondary battery having excellent cycle characteristics.

In order to solve the above-described problems or other problems, the following means is provided according to some embodiments of the present disclosure:
(1) A lithium-ion secondary battery according to a first aspect has a positive electrode, a negative electrode, a separator present between the positive electrode and the negative electrode and an electrolytic solution. The negative electrode contains silicon or a silicon compound and a binder. The binder contains polyimide. When the negative electrode after discharging is observed by nuclear magnetic resonance (NMR) spectroscopy using a single-pulse magic-angle spinning method (SP-MAS method) and peaks are separated by a Gaussian function, a Lorentzian function or a Voigt function, an NMR spectrum of a solid⁷ Li nucleus has a first peak, and the first peak has a peak top in a chemical shift range of 0.5 ppm or more and 1.5 ppm or less with Li in LiCoO₂ set to −0.5 ppm.
(2) In the lithium-ion secondary battery according to the above-described aspect, the MAS NMR spectrum of the solid⁷ Li nucleus may further have a second peak. The second peak has a peak top at a chemical shift position of 2.4 ppm with Li in LiCoO₂ set to −0.5 ppm.
(3) In the lithium-ion secondary battery according to the above-described aspect, when the negative electrode after charging and after discharging is observed by nuclear magnetic resonance (NMR) spectroscopy using a cross-polarization magic-angle spinning method (CP-MAS method), MAS NMR spectra of a solid¹³ C nucleus may further have a third peak. The third peak has a peak top in a chemical shift range of 120 ppm or more and 170 ppm or less with a high magnetic field-side peak of an NMR spectrum of hexamethyl benzene set to 16.81 ppm.
(4) In the lithium-ion secondary battery according to the above-described aspect, the polyimide may be aromatic polyimide.

The lithium-ion secondary battery according to the above-described aspect is excellent in terms of cycle characteristics.

### BRIEF DESCRIPTION OF THE DRAWINGS

The scope of the present disclosure is best understood from the following detailed description of exemplary embodiments when read in conjunction with the accompanying drawings.

FIG. 1 is a schematic view of a lithium-ion secondary battery according to a first embodiment of the present disclosure.

FIG. 2 is a result of nuclear magnetic resonance (NMR) spectroscopy of a negative electrode according to the present embodiment using a single-pulse magic-angle spinning method (SP-MAS method) according to one embodiment of the present disclosure.

FIG. 3 is an enlarged view of a MAS NMR spectrum of a solid⁷ Li nucleus in the negative electrode according to the present embodiment within a predetermined range (horizontal axis: −40 ppm to 50 ppm) according to one embodiment of the present disclosure.

FIG. 4 is a result of nuclear magnetic resonance (NMR) spectroscopy of the negative electrode according to the present embodiment using a cross-polarization magic-angle spinning method (CP-MAS method) according to one embodiment of the present disclosure.

FIG. 5 is a result of nuclear magnetic resonance (NMR) spectroscopy of the negative electrode according to the present embodiment using a cross-polarization magic-angle spinning method (CP-MAS method) according to one embodiment of the present disclosure.

### DETAILED DESCRIPTION OF THE DISCLOSURE

Hereinafter, an embodiment will be described in detail with appropriate reference to the drawings. In the drawings to be used in the following description, there will be cases where a characteristic part is illustrated in an enlarged manner for convenience in order to facilitate the understanding of the characteristics, and the dimensional proportion and the like of each configuration element are different from actual ones in some cases. Materials, dimensions and the like in the following description are simply exemplary examples, and the present disclosure is not limited thereto and can be appropriately modified and carried out within the scope of the gist of the present disclosure.

### “Lithium-Ion Secondary Battery”

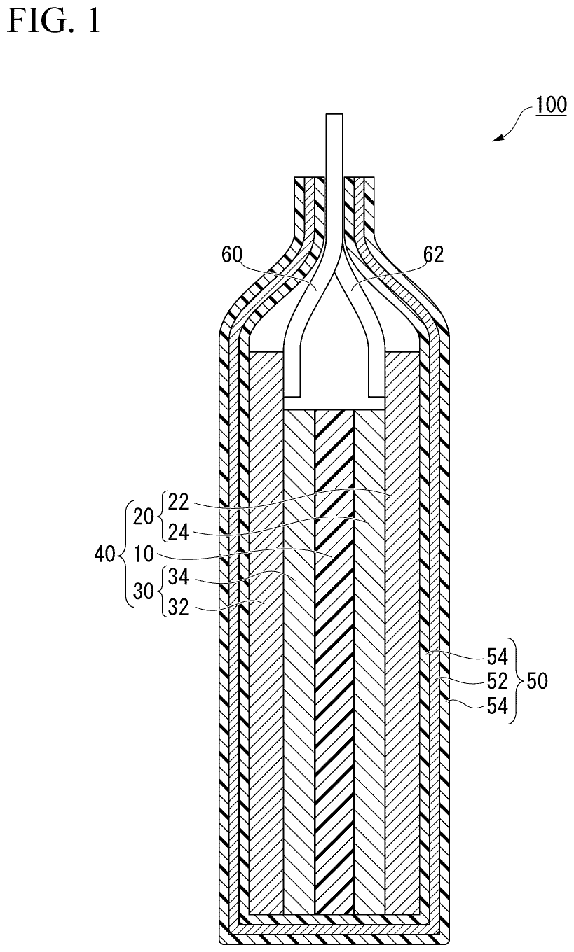

FIG. 1 is a schematic view of a lithium-ion secondary battery according to a first embodiment of the present disclosure. A lithium-ion secondary battery 100 illustrated in FIG. 1 includes a power generation element 40, an exterior body 50 and a non-aqueous electrolytic solution. The exterior body 50 coats the circumference of the power generation element 40. The power generation element 40 is connected to the outside with a pair of terminals 60 and 62 connected to each other. The non-electrolytic solution is accommodated in the exterior body 50. In FIG. 1, a case where one power generation element 40 is present in the exterior body 50 is an exemplary example, but a plurality of power generation elements 40 may be laminated.

### (Power Generation Element)

The power generation element 40 includes, for example, a separator 10, a positive electrode 20 and a negative electrode 30. The power generation element 40 may be a laminate where these members are laminated or a wound body where a structure in which these members are laminated is wound.

### <Positive Electrode>

The positive electrode 20 has, for example, a positive electrode current collector 22 and a positive electrode active material layer 24. The positive electrode active material layer 24 is in contact with at least one surface of the positive electrode current collector 22.

### [Positive Electrode Current Collector]

The positive electrode current collector 22 is, for example, a conductive sheet material. The positive electrode current collector 22 is, for example, a thin metal sheet of aluminum, copper, nickel, titanium, stainless steel or the like. Aluminum having a light weight can be suitably used as the positive electrode current collector 22. The average thickness of the positive electrode current collector 22 is, for example, 10 μm or more and 30 μm or less.

### [Positive Electrode Active Material Layer]

The positive electrode active material layer 24 contains, for example, a positive electrode active material. The positive electrode active material layer 24 may contain a conductive assistant and a binder as necessary.

The positive electrode active material may contain an electrode active material capable of reversibly progressing the emission and insertion (or intercalation) of lithium ions, or the doping and de-doping of lithium ions and counter anions.

The positive electrode active material is, for example, a composite metal oxide. The composite metal oxide is, for example, lithium cobalt oxide (LiCoO₂), lithium nickel oxide (LiNiO₂), lithium manganese dioxide (LiMnO₂), lithium manganese spinel (LiMn₂O₄), a compound of a general formula: LiNiₓCo_{y}Mn_{z}MₐO₂ (in the general formula, x+y+z+a=1, 0≤x<1, 0≤y<1, 0≤z<1, 0≤a<1 and M is one or more elements selected from Al, Mg, Nb, Ti, Cu, Zn and Cr), a lithium vanadium compound (LiV₂O₅), olivine-type LiMPO₄ (here, M represents one or more elements selected from Co, Ni, Mn, Fe, Mg, Nb, Ti, Al and Zr or VO), lithium titanate (Li₄Ti₅O₁₂) or LiaNiₓCo_{y}Al_{z}O₂ (0.9<x+y+z<1.1). The positive electrode active material may be an organic substance. For example, the positive electrode active material may be polyacetylene, polyaniline, polypyrrole, polythiophene or polyacene.

The positive electrode active material may be a non-lithium-containing material. The non-lithium-containing material is, for example, FeF₃, a conjugated polymer containing an organic conductive substance, a Chevrel phase compound, a transition metal chalcogenide, vanadium oxide, niobium oxide or the like. As the non-lithium-containing material, any one material may be used alone or a plurality of materials may be used in combination. In a case where the positive electrode active material is the non-lithium-containing material, for example, the positive electrode active material is discharged first. Discharging causes lithium to be intercalated into the positive electrode active material. Additionally, the positive electrode active material may be a non-lithium-containing material chemically or electrochemically pre-doped with lithium.

The conductive assistant may enhance electron conductivity between the particles of the positive electrode active material. The conductive assistant is, for example, a carbon powder, carbon nanotubes, a carbon material, a fine metal powder, a mixture of a carbon material and a fine metal powder or a conductive oxide. The carbon powder is, for example, carbon black, acetylene black, ketjen black or the like. The fine metal powder is, for example, a powder of copper, nickel, stainless steel, iron or the like.

The content rate of the conductive assistant in the positive electrode active material layer 24 is not particularly limited. For example, the content rate of the conductive assistant relative to the total mass of the positive electrode active material, the conductive assistant and the binder is 0.5 mass % or more and 20 mass % or less and preferably 1 mass % or more and 5 mass % or less.

The binder in the positive electrode active material layer 24 binds the particles of the positive electrode active material together. As the binder, a well-known binder can be used. As the binder, a binder that does not dissolve in electrolytic solutions and has oxidation resistance and adhesiveness is preferable. The binder is, for example, a fluororesin. The binder is, for example, polyvinylidene fluoride (PVDF), polyvinyl alcohol (PVA), polytetrafluoroethylene (PTFE), polyamide (PA), polyimide (PI), polyamide-imide (PAI), poly benzimidazole (PBI), polyether sulfone (PES), polyacrylic acids or a copolymer thereof, a metal ion-crosslinked product of a polyacrylic acid or a copolymer thereof, polypropylene (PP) or polyethylene (PE) in which maleic anhydride is grafted or a mixture thereof. The binder that is used in the positive electrode active material is particularly preferably PVDF.

The content rate of the binder in the positive electrode active material layer 24 is not particularly limited. For example, the content rate of the binder relative to the total mass of the positive electrode active material, the conductive assistant and the binder is 1 mass % or more and 15 mass % or less and preferably 1.5 mass % or more and 5 mass % or less. When the content rate of the binder is low, the adhesive strength of the positive electrode 20 weakens. When the content rate of the binder is high, since the binder is electrochemically inactive and does not contribute to the discharge capacity, the energy density of the lithium-ion secondary battery 100 becomes low.

### <Negative Electrode>

The negative electrode 30 has, for example, a negative electrode current collector 32 and a negative electrode active material layer 34. The negative electrode active material layer 34 is formed on at least one surface of the negative electrode current collector 32.

### [Negative Electrode Current Collector]

The negative electrode current collector 32 is, for example, a conductive sheet material. As the negative electrode current collector 32, the same current collector as the positive electrode current collector 22 can be used.

### [Negative Electrode Active Material Layer]

The negative electrode active material layer 34 may contain a negative electrode active material and a binder. The negative electrode active material layer may contain a conductive assistant, a dispersion stabilizer or the like as necessary.

The negative electrode active material contains silicon or a silicon compound. The amount of silicon or the silicon compound is preferably 50 mass % or more and more preferably 70 mass % or more relative to the total amount of the negative electrode active material. The silicon compound is, for example, a silicon alloy, a silicon oxide or the like. For example, silicon or the silicon compound may be crystalline or amorphous. Amorphous silicon or silicon compounds can be produced by a melt span method, a gas atomization method or the like.

The silicon alloy is represented by XnSi. X is a cation. X is, for example, Ba, Mg, Al, Zn, Sn, Ca, V, Cr, Mn, Fe, Co, Ni, Cu, Zn, Ge, Y, Zr, Nb, Mo, W, Au, Ti, Na, K or the like. n satisfies 0≤n≤0.5. The silicon oxide is represented by SiOₓ. x satisfies, for example, 0.8≤x≤2. The silicon oxide may be composed of SiO₂ alone, may be composed of SiO alone or may be composed of a mixture of SiO and SiO₂. In addition, some oxygen atoms may lack in the silicon oxide.

The negative electrode active material may be a composite body of silicon or a silicon compound. In the composite body, at least some of the surfaces of the particles of silicon or the silicon compound are coated with a conductive material. The conductive material is, for example, a carbon material, Al, Ti, Fe, Ni, Cu, Zn, Ag, Sn or the like. For example, a silicon-carbon composite material (Si—C) is an example of the composite body. The amount of the conductive material that coat the particles of silicon or the silicon compound is, for example, 0.01 mass % or more and 30 mass % or less and preferably 0.1 mass % or more and 20 mass % or less relative to the total mass of the composite body. The composite body can be produced by, for example, a mechanical alloying method, a chemical vapor deposition method, a wet method, a method in which a polymer is coated and then thermally decomposed to be carbonized or the like.

The specific surface area of the negative electrode active material obtained by a BET method is, for example, 0.5 m²/g or more and 100 m²/g or less and preferably 1.0 m²/g or more and 20 m²/g or less. When the specific surface area is small, it becomes difficult for Li ions to be intercalated between and deintercalated from the particles of the negative electrode active material. When the specific surface area is large, a large amount of a binder is required to produce the electrode, and the capacity per unit volume becomes small.

The binder in the negative electrode active material layer 34 contains polyimide. The binder may contain, in addition to the polyimide, for example, any of the binders that can be used in the positive electrode active material layer 24, carboxymethyl cellulose (CMC), styrene-butadiene rubber (SBR) or the like.

The polyimide is, for example, a polymer including an imide structure in the repeating unit structure. The polyimide is a polymer of an acid anhydride and a diamine compound, and both the acid anhydride and the diamine compound preferably have an aromatic ring. The polyimide may include, for example, a cyclic imide structure and an aromatic compound in the repeating unit structure. The cyclic imide structure contains, for example, pentacyclic imide.

The content rate of the binder in the negative electrode active material layer 34 is not particularly limited. For example, the content rate of the binder relative to the total mass of the negative electrode active material, the conductive assistant and the binder is 1 mass % or more and 20 mass % or less and preferably 3 mass % or more and 15 mass % or less. When the content rate of the binder is low, the adhesive strength of the negative electrode 30 weakens. When the content rate of the binder is high, since the binder is electrochemically inactive and does not contribute to the discharge capacity, the energy density of the lithium-ion secondary battery 100 becomes low.

The conductive assistant in the negative electrode active material layer 34 may enhance electron conductivity between the particles of the negative electrode active material. As the conductive assistant, the same conductive assistant as in the positive electrode active material layer 24 can be used.

The content rate of the conductive assistant in the negative electrode active material layer 34 is not particularly limited. For example, the content rate of the conductive assistant relative to the total mass of the negative electrode active material, the conductive assistant and the binder is 5 mass % or more and 20 mass % or less and preferably 1 mass % or more and 12 mass % or less. The BET specific surface area of the conductive assistant is, for example, 100 m²/g or more and 200 m²/g or less.

The dispersion stabilizer in the negative electrode active material layer 34 is, for example, polyvinylpyrrolidone (PVP). The dispersion stabilizer prevents the agglomeration of the negative electrode active material during the production of a slurry.

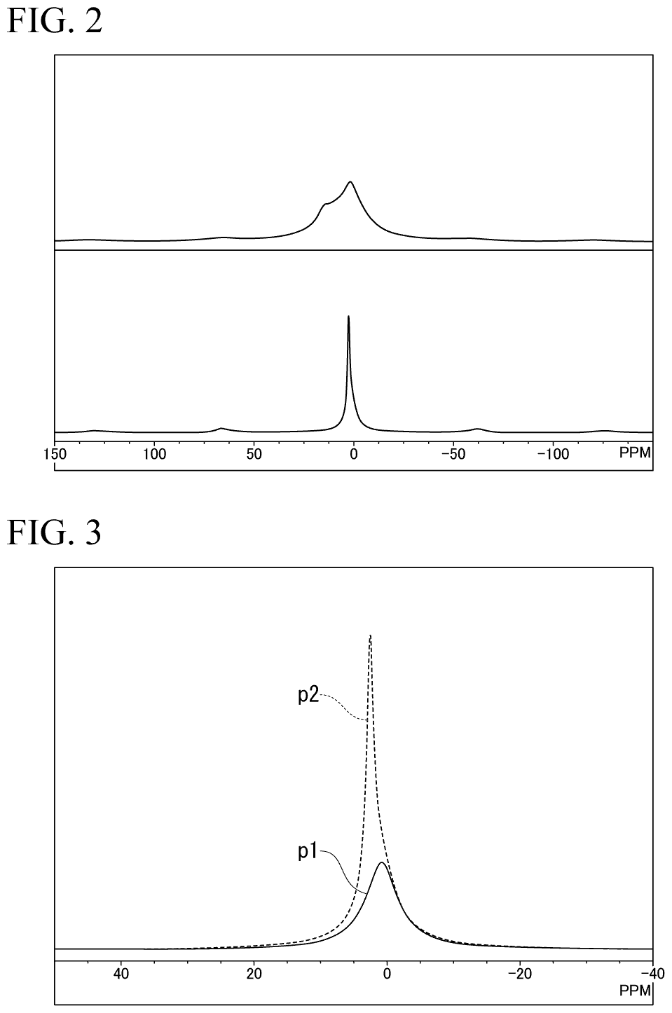

FIG. 2 is the result of nuclear magnetic resonance (NMR) spectroscopy of the negative electrode according to one embodiment of the present disclosure using a single-pulse magic-angle spinning method (SP-MAS method). FIG. 2 is the NMR spectrum of a solid⁷ Li nucleus obtained by the NMR spectroscopy of the negative electrode. The upper drawing of FIG. 2 is the measurement result of the negative electrode after charging, and the lower drawing is the measurement result of the negative electrode after discharging. The horizontal axis is the chemical shift (ppm) and represented by [(“the frequency of an electromagnetic wave at which absorption occurs”−“the absorption frequency of a reference substance”)/“the intensity of a magnetic field”]×10⁶. As the reference, Li in LiCoO₂ was set to −0.5 ppm. The intensity of the applied magnetic field was set to 6.4 T (272 MHZ).

The magic-angle spinning method is a method in which a sample is rotated at a high speed around, as an axis, a direction inclined with respect to the application direction of a magnetic field and the signal of solid NMR is sharpened. The rotation speed of the sample was set to 15 KHz.

FIG. 3 is an enlarged view of the NMR spectrum of the solid⁷ Li nucleus in the negative electrode according to one embodiment of the present disclosure within a predetermined range (horizontal axis: −40 ppm to 50 ppm). The spectrum illustrated in FIG. 3 illustrates the peak separation result of overlapped peaks using a Voigt function. The peak separation of the overlapped peaks may also be carried out using a Lorentzian function or a Gaussian function.

As illustrated in FIG. 3, the NMR spectrum of the solid⁷ Li nucleus of the negative electrode has, for example, a first peak p1 and a second peak p2. “First”, “second” and the like are simply ordinal numbers and do not indicate the magnitudes of peaks. The first peak p1 illustrated in FIG. 3 has a peak top at a chemical shift position of 0.95 ppm. The second peak p2 illustrated in FIG. 3 has a peak top at a chemical shift position of 2.4 ppm.

The first peak p1 is a peak derived from a reaction product of the polyimide and lithium (absorption of lithium by the polyimide). The first peak p1 is a peak that is confirmed first by a sufficient reaction between the polyimide and lithium. In other words, even when the polyimide and lithium are simply contained at the same time as configuration materials for the production of the negative electrode active material layer, the peak is not confirmed. A method for sufficiently reacting the polyimide and lithium will be described below. The peak top position of the first peak p1 changes depending on the state (kind, polymerization state, degree of polymerization) of the polyimide. The first peak p1 has a peak top in a chemical shift range of 0.5 ppm or more and 1.5 ppm or less.

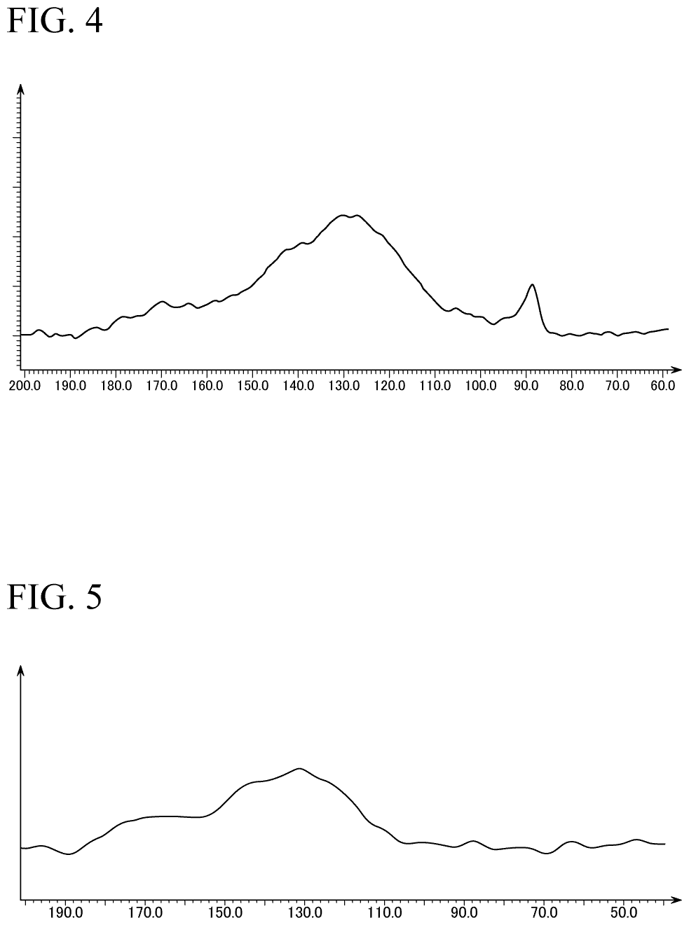

FIG. 4 and FIG. 5 are the results of nuclear magnetic resonance (NMR) spectroscopy of the negative electrode according to one embodiment of the present disclosure using a cross-polarization magic-angle spinning method (CP-MAS method). FIG. 4 is the NMR spectrum result of a solid¹³ C nucleus of the negative electrode after charging, and FIG. 5 is the NMR spectrum result of the solid¹³ C nucleus of the negative electrode after discharging. The horizontal axis is the chemical shift (ppm) and represented by [(“the frequency of an electromagnetic wave at which absorption occurs”−“the absorption frequency of a reference substance”)/“the intensity of a magnetic field”]×10⁶. As the reference, the high magnetic field-side peak of hexamethyl benzene in the NMR spectrum was set to 16.81 ppm. The intensity of the applied magnetic field was set to 4.1 T (176 MHz). The rotation speed of the sample was set to 15 KHz.

As illustrated in FIG. 4 and FIG. 5, the NMR spectra of the solid¹³ C nucleus of the negative electrode have, for example, a broad third peak. “Third” is simply an ordinal number and does not indicate the magnitude of the peak. The third peaks illustrated in FIG. 4 and FIG. 5 have a peak top at a chemical shift position of 130 ppm.

The third peak is a peak derived from a reaction product of the polyimide and lithium (absorption of lithium by the polyimide). Nuclear magnetic resonance spectroscopy shows that the polyimide before being incorporated into the negative electrode has several peaks based on bonding groups. When the polyimide absorbs lithium due to a charging and discharging reaction, the bonding state changes, and these peaks become broad. The third peak is one of the peaks that are generated to be broad. The third peak is a peak that is confirmed first by a sufficient reaction between the polyimide and lithium. In other words, even when the polyimide and lithium are simply contained at the same time as configuration materials for the production of the negative electrode active material layer, the peak is not confirmed. A method for sufficiently reacting the polyimide and lithium will be described below. The peak top position of the third peak changes depending on the state (kind, polymerization state, degree of polymerization) of the polyimide. The third peak has a peak top in a chemical shift range of 120 ppm or more and 170 ppm or less.

### <Separator>

In some embodiments, the separator 10 is sandwiched by the positive electrode 20 and the negative electrode 30. The separator 10 isolates the positive electrode 20 and the negative electrode 30 and prevents a short circuit between the positive electrode 20 and the negative electrode 30. The separator 10 spreads in the plane along the positive electrode 20 and the negative electrode 30. Lithium ions are capable of passing through the separator 10.

The separator 10 has, for example, an electrically insulating porous structure. The separator 10 is, for example, a single-layer polyolefin film or a laminate of polyolefin films. The separator 10 may be a stretched film of a mixture of polyethylene, polypropylene or the like. The separator 10 may be a fiber non-woven fabric composed of at least one configuration material selected from the group consisting of cellulose, polyester, polyacrylonitrile, polyamide, polyethylene and polypropylene. The separator 10 may be, for example, a solid electrolyte. The solid electrolyte is, for example, a polymer solid electrolyte, an oxide-based solid electrolyte or a sulfide-based solid electrolyte. The separator 10 may be an inorganic coating separator. The inorganic coating separator is a separator obtained by applying a mixture of a resin, such as PVDF or CMC, and an inorganic substance, such as alumina or silica, to the surface of the above-described film. The inorganic coating separator has excellent heat resistance and suppresses the precipitation of a transition metal eluted from the positive electrode on the surface of the negative electrode.

### <Electrolytic Solution>

The electrolytic solution may be enclosed in the exterior body 50 and used to impregnate the power generation element 40. A non-aqueous electrolytic solution has, for example, a non-aqueous solvent and an electrolytic salt. The electrolytic salt is in a state of being dissolved in the non-aqueous solvent.

The solvent is not particularly limited as long as the solvent is ordinarily used in lithium-ion secondary batteries. The solvent contains, for example, any of a cyclic carbonate compound, a chain carbonate compound, a cyclic ester compound and a chain ester compound. The solvent may contain these in arbitrary proportions as a mixture. The cyclic carbonate compound is, for example, ethylene carbonate (EC), propylene carbonate (PC), fluoroethylene carbonate, vinylene carbonate or the like. The chain carbonate compound is, for example, diethyl carbonate (DEC), ethyl methyl carbonate (EMC) or the like. The cyclic ester compound is, for example, γ-butyrolactone or the like. The chain ester compound is, for example, propyl propionate, ethyl propionate, ethyl acetate or the like.

The electrolytic salt is, for example, a lithium salt. An electrolyte is, for example, LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, LiN(FSO₂)₂ or the like. One lithium salt may be used singly or two or more lithium salts may be jointly used. From the viewpoint of the degree of electrolytic dissociation, the electrolyte preferably contains LiPF₆. The deviation of the electrolytic salt at room temperature in a carbonate solvent is preferably 10% or more.

The electrolytic solution is preferably, for example, an electrolytic solution containing LiPF₆ dissolved in a carbonate solvent. The concentration of LiPF₆ is, for example, 1 mol/L. In a case where a polyimide resin contains a large amount of an aromatic compound, the polyimide resin exhibits charging behaviors of soft carbon in some cases. In a case where the electrolytic solution is a carbonate electrolytic solution containing cyclic carbonate, it is possible to uniformly react lithium with the polyimide. In this case, the cyclic carbonate is preferably ethylene carbonate, fluoroethylene carbonate or vinylene carbonate.

### <Exterior Body>

The exterior body 50 may seal the power generation element 40 and the non-aqueous electrolytic solution therein. The exterior body 50 may suppress the leakage of the non-aqueous electrolytic solution to the outside, the intrusion of moisture or the like into the lithium-ion secondary battery 100 from the outside or the like.

The exterior body 50 has, for example, a metal foil 52 and a resin layer 54 laminated on each surface of the metal foil 52 as illustrated in FIG. 1. The exterior body 50 is a metal-laminated film obtained by coating the metal foil 52 with polymer films (resin layers 54) on both sides.

As the metal foil 52, for example, an aluminum foil can be used. As the resin layer 54, a polymer film of polypropylene or the like can be used. Materials that configure the outside and inside resin layers 54 may be different from each other. For example, it is possible to use a polymer having a high melting point, for example, polyethylene terephthalate (PET), polyamide (PA) or the like as the outside material and to use polyethylene (PE), polypropylene (PP) or the like as the material of the inside polymer film.

### <Terminal>

The terminals 60 and 62 are each connected to the positive electrode 20 or the negative electrode 30. The terminal 60 connected to the positive electrode 20 is a positive electrode terminal, and the terminal 62 connected to the negative electrode 30 is a negative electrode terminal. The terminals 60 and 62 play a role of electrical connection with the outside. The terminals 60 and 62 may be formed of a conductive material such as aluminum, nickel, copper or the like. The connection method may be welding or screw fastening. The terminals 60 and 62 are preferably protected with insulating tape in order to prevent a short circuit.

### “Method for Manufacturing Lithium-Ion Secondary Battery”

The lithium-ion secondary battery 100 is produced by preparing each of the negative electrode 30, the positive electrode 20, the separator 10, the electrolytic solution and the exterior body 50 and assembling these. Hereinafter, an example of the method for manufacturing the lithium-ion secondary battery 100 will be described.

The negative electrode 30 is produced by, for example, carrying out a slurry production step, an electrode application step, a drying step and a rolling step in order.

The slurry production step is a step of making a slurry by mixing a negative electrode active material (silicon or a silicon compound), a binder, a conductive assistant and a solvent. As the binder, the above-described binder is used. When a dispersion stabilizer is added to the slurry, it is possible to suppress agglomeration of the negative electrode active material.

The slurry is produced by, specifically, the following procedure. First, polyamic acid, which serves as the binder, is diluted with a N-methyl-2-pyrrolidone (NMP) solution in a resin container. The resin container is preferably a container having a low contact angle with the main solvent and is preferably, for example, a fluororesin container. When a resin container is used, it is possible to suppress a reaction between the container and the slurry.

Next, the polyamic acid is stirred at 1000 rpm or faster so as to be uniformly dispersed in the solution. The conductive assistant is added to the solution a plurality of times in divided quantities and stirred at 1000 rpm or faster for several minutes each time the conductive assistant is added. The dispersion stabilizer is added, for example, at the same time as the conductive assistant.

Next, the negative electrode active material is added to the slurry containing the polyamic acid and the conductive assistant a plurality of times in divided quantities and stirred at 1000 rpm or faster for several minutes each time the negative electrode active material is added. Since the optimal stirring rotation speed for the production of the slurry varies with apparatuses, means may be any method as long as a uniform dispersion liquid can be produced.

In the case of a water-soluble binder, an intended slurry can be produced by changing the diluent solution to water and carrying out an equivalent treatment. In a case where water is used as the main solvent, it is desirable to use a resin container of polypropylene or the like rather than a fluororesin.

When the dispersibility of the slurry is enhanced, it becomes possible for charged or discharged lithium ions to react with the negative electrode active material and the negative electrode binder.

The electrode application step is a step of applying the slurry to the surface of the negative electrode current collector 32. The method for applying the slurry is not particularly limited. For example, it is possible to use a slit die coating method or a doctor blade method as the method for applying the slurry. The slurry is applied at, for example, room temperature.

The drying step is a step of removing the solvent from the slurry. For example, the negative electrode current collector 32 to which the slurry has been applied is dried in an atmosphere of 80° C. to 350° C. In addition, in the drying step, a ring-closing reaction of the polyamic acid, which is a precursor, may be progressed. In this case, the drying step is preferably carried out at 200° C. or higher and 350° C. or lower. When the slurry is dried or the ring-closing reaction is progressed, the negative electrode active material layer 34 is formed on the negative electrode current collector 32.

The rolling step is carried out as necessary. The rolling step is a step of adjusting the density of the negative electrode active material layer 34 by applying a pressure to the negative electrode active material layer 34. The rolling step is carried out with, for example, a roll pressing apparatus or the like. After the rolling step, the resistance of the negative electrode is measured with an electrical resistance measuring instrument or the cross section is observed with a scanning electron microscope, which makes it possible to confirm that each configuration element is uniformly dispersed in the negative electrode active material layer.

The positive electrode 20 can be produced by the same procedure as for the negative electrode 30. As the separator 10 and the exterior body 50, commercially available separator and exterior body can be used.

Next, the produced positive electrode 20 and negative electrode 30 and the separator 10 are laminated such that the separator 10 is positioned between the positive electrode 20 and the negative electrode 30 to produce the power generation element 40. In a case where the power generation element 40 is a wound body, the positive electrode 20, the negative electrode 30 and the separator 10 are wound around one end side thereof as an axis.

Finally, the power generation element 40 is enclosed in the exterior body 50. The non-aqueous electrolytic solution is poured into the exterior body 50. After being poured, the non-aqueous electrolytic solution is depressurized, heated and the like, whereby the power generation element 40 is impregnated with the non-aqueous electrolytic solution. The exterior body 50 is sealed by applying heat or the like thereto, thereby obtaining the lithium-ion secondary battery 100. Instead of pouring the electrolytic solution into the exterior body 50, the power generation element 40 may be impregnated with the electrolytic solution. After being poured into the power generation element, the electrolytic solution is preferably placed still for 24 hours.

In the lithium-ion secondary battery 100 according to the first embodiment of the present disclosure, the binder is polyimide having a high strength compared with polyacrylic acid (PAA) or the like, and the lithium-ion secondary battery is capable of following even when the negative electrode active material expands or constricts. In addition, the polyimide is sufficiently uniformly dispersed in the negative electrode active material layer, whereby the polyimide uniformly occludes lithium, and the cycle characteristics improve. In a case where the lithium occlusion of the polyimide is nonuniform, a predetermined peak is not generated in NMR. In a case where the lithium occlusion of the polyimide is nonuniform, the reaction of the electrode also becomes nonuniform, and the lithium-ion secondary battery is not capable of exhibiting sufficient cycle characteristics.

Hitherto, the embodiment of the present disclosure has been described in detail with reference to the drawings, but each configuration in each embodiment, a combination thereof, and the like are examples, and the addition, omission, substitution and other modifications of the configuration are possible within the scope of the gist of the present disclosure.

### EXAMPLES

### Example 1

A positive electrode slurry was applied to one surface of a 15 μm-thick aluminum foil. The positive electrode slurry was produced by mixing a positive electrode active material, a conductive assistant, a binder and a solvent.

As the positive electrode active material, LiₓCoO₂ was used. As the conductive assistant, acetylene black was used. As the binder, polyvinylidene fluoride (PVDF) was used. As the solvent, N-methyl-2-pyrrolidone was used. 97 Parts by mass of the positive electrode active material, 1 part by mass of the conductive assistant, 2 parts by mass of the binder and 70 parts by mass of the solvent were mixed to produce the positive electrode slurry. The amount of the positive electrode active material supported in a dried positive electrode active material layer was set to 25 mg/cm². The solvent was removed from the positive electrode slurry in a drying furnace, and the positive electrode active material layer was made. The positive electrode active material layer was pressurized with a roll press, thereby producing a positive electrode.

Next, a negative electrode slurry was produced. As a negative electrode active material, silicon having an average particle diameter of 3 μm was used. As a conductive assistant, carbon black was used. As a binder, a polymer of polyamic acid of the following chemical formula (1) was used. The weight-average molecular weight of the binder was set to 35,000.

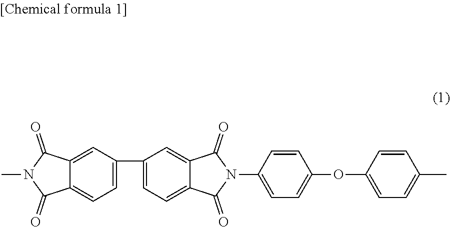

First, the above-described compound was diluted with a N-methyl-2-pyrrolidone (NMP) solution in a resin container. Next, the compound was stirred at 1000 rpm for one minute so as to be uniformly dispersed in the solution. Next, the conductive assistant and a dispersion stabilizer were added to the solution a plurality of times in divided quantities and stirred at 1000 rpm for several minutes each time the conductive assistant was added. As the dispersion stabilizer, polyvinylpyrrolidone was used. Next, silicon was added to a slurry a plurality of times in divided quantities and stirred at 1000 rpm for several minutes each time silicon was added.

In addition, the negative electrode slurry was applied to one surface of a 10 μm-thick copper foil and dried. The amount of the negative electrode active material supported in a dried negative electrode active material layer was set to 2.5 mg/cm². The negative electrode active material layer was pressurized with a roll press and then thermally fired in a nitrogen atmosphere at 300° C. or higher for five hours.

Next, an electrolytic solution was produced. As a solvent for the electrolytic solution, a mixture of fluoroethylene carbonate (FEC), ethylene carbonate (EC) and propylene carbonate (PC) (10 vol %: 20 vol %: 70 vol %) was used. In addition, an additive for output improvement, an additive for gas suppression, an additive for cycle characteristic improvement, a safety performance improvement additive or the like was added to the electrolytic solution. As an electrolytic salt, LiPF₆ was used. The concentration of LiPF₆ was set to 1 mol/L.

### (Production of Lithium-Ion Secondary Battery for Evaluation)

The produced positive electrode and negative electrode were laminated with a separator (porous polyethylene sheet) interposed therebetween such that the positive electrode active material layer and the negative electrode active material layer faced each other to obtain a laminate. This laminate was inserted into an exterior body of an aluminum-laminated film and heat-sealed except one place of the circumference to form a closing portion. In addition, finally, the electrolytic solution was poured into the exterior body and sealed by heat-sealing the remaining one place with a vacuum sealing machine while depressurizing, thereby producing a lithium-ion secondary battery. The produced lithium-ion secondary battery was placed still for 24 hours. Two lithium-ion secondary batteries were produced under the same conditions, one battery was used for the evaluation of the cycle characteristics, and the other was used for NMR measurement.

(Measurement of Capacity Retention Rate after 300 Cycles)

The cycle characteristics of the lithium-ion secondary battery were measured. The cycle characteristics were measured using a secondary battery charge/discharge testing apparatus (manufactured by Hokuto Denko Corporation).

Charging was carried out by constant-current charging at a charging rate of 1C (a current value by which charging was ended in one hour when constant-current charging was carried out at 25° C.) until the battery voltage reached 4.2 V, and discharging was carried out by constant-current discharging at a discharging rate of 1.0 C until the battery voltage reached 2.5 V. The discharge capacity after the end of the charging and discharging was detected, and the battery capacity Q₁ before a cycle test was obtained.

On the battery from which the battery capacity Q₁ had been obtained as described above, again, charging was carried out by constant-current charging at a charging rate of 1C until the battery voltage reached 4.2 V, and discharging was carried out by constant-current discharging at a discharging rate of 1C until the battery voltage reached 2.5 V using secondary battery charge/discharge testing apparatus. The above-described charging and discharging was defined as one cycle, and 300 cycles of charging and discharging were carried out. After that, the discharge capacity after the end of the 300 cycles of charging and discharging was detected, and the battery capacity Q₂ after the 300 cycles was obtained. From the capacities Q₁ and Q₂ obtained above, the capacity retention rate E after the 300 cycles was obtained. The capacity retention rate E can be obtained by E=Q₂/Q₁×100. The capacity retention rate of Example 1 was 82.4%.

### (NMR Measurement)

The produced lithium-ion secondary battery was charged for five hours up to a fully-charged state and placed still for 12 hours in the fully-charged state. After that, the lithium-ion secondary battery in the fully-charged state was discharged for five hours. Next, the sample after the discharging was disassembled in a glove box in an argon gas atmosphere, and the negative electrode was removed. The negative electrode was washed with dimethyl carbonate (DMC). In addition, the negative electrode active material layer was peeled off from the copper foil (negative electrode current collector) using a TEFLON (registered trademark) spatula and dried.

The dried negative electrode active material layer was stored in a zirconia sample tube, and solid NMR measurement was carried out at 700 MHz. A solid⁷ Li nucleus was measured by an SP-MAS method, and a solid¹³ C nucleus was measured by a CP-MAS method. FIG. 2 to FIG. 5 are the evaluation results of Example 1. As illustrated in FIG. 2 to FIG. 5, all of a first peak to a third peak were confirmed. The peak top of the first peak was at a chemical shift position of 0.95 ppm. The peak top of the second peak was at a chemical shift position of 2.4 ppm. The peak top of the third peak was at a chemical shift position of 130 ppm.

### Comparative Example 1

Comparative Example 1 is different from Example 1 in that, at the time of producing a slurry, polyamic acid, silicon and a conductive assistant were added to a N-methyl-2-pyrrolidone (NMP) solution at once and a dispersion stabilizer was not added. The slurry was produced by adding polyamic acid, silicon and the conductive assistant to the N-methyl-2-pyrrolidone (NMP) solution at once and then stirring the components at slower than 1000 rpm for several minutes.

The capacity retention rate of Comparative Example 1 was 54.3%. In addition, from a negative electrode active material layer of Comparative Example 1, a first peak and a third peak were not confirmed. A second peak was confirmed even in the negative electrode active material layer of Comparative Example 1.

### Example 2

Example 2 is different from Example 1 in that the material of the polyimide was changed. In Example 2, a polymer of polyamic acid represented by the following chemical formula (2) was used as a binder. The chemical formula (2) is different in that an imide ring is bonded by a phenyl group. The other conditions of Example 2 were set to be the same as those in Example 1.

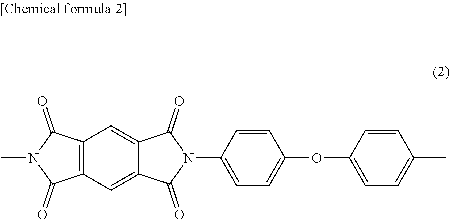

The capacity retention rate of Example 2 was 81.2%. In addition, in the NMR spectroscopy of the negative electrode active material layer of Example 2, all of a first peak to a third peak were confirmed. The peak top of the first peak was at a chemical shift position of 0.5 ppm. The peak top of the second peak was at a chemical shift position of 2.4 ppm. The peak top of the third peak was at a chemical shift position of 140 ppm.

### Example 3

Example 3 is different from Example 1 in that an aqueous solution-based aromatic polyimide binder was used. The other conditions were set to be the same as those in Example 1.

The capacity retention rate of Example 3 was 80.4%. In addition, in the NMR spectroscopy of the negative electrode active material layer of Example 2, all of a first peak to a third peak were confirmed. The peak top of the first peak was at a chemical shift position of 1.5 ppm. The peak top of the second peak was at a chemical shift position of 2.4 ppm. The peak top of the third peak was at a chemical shift position of 130 ppm.

### Comparative Example 2

Comparative Example 2 is different from Example 1 in that a non-aromatic cyclic imide polymer represented by the following chemical formula (3) was used as a binder. The other conditions were set to be the same as those in Example 1.

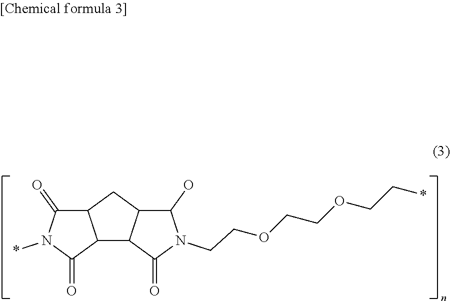

The capacity retention rate of Comparative Example 2 was 63.2%. In addition, from the negative electrode active material layer of Comparative Example 1, a weak first peak was detected at 0.15 ppm. A second peak was confirmed even in the negative electrode active material layer of Comparative Example 1.

The results of the examples and the comparative examples were summarized below.

TABLE 1

| | | | | Capacity |
|---|---|---|---|---|
| | | | | retention rate |
| | Chemical shift (ppm) | | | (%) |
| | First peak | Second peak | Third peak | After 300 cycles |
| Example 1 | 0.95 | 2.4 | 130 br | 82.4 |
| Comparative | — | 2.4 | — | 54.3 |
| Example 1 | | | | |
| Example 2 | 0.50 | 2.4 | 140 br | 81.2 |
| Example 3 | 1.50 | 2.4 | 130 br | 80.4 |
| Comparative | — | 2.4 | 176 sh, <50 sh | 63.2 |
| Example 2 | | | | |

In Table 1, br means a broad peak, and sh means a sharp peak. <50 sh means that a sharp peak is present at 50 ppm or less. The first peak and the second peak are the peaks of the solid⁷ Li nucleus NMR and the results of peak separation by a Voigt function and are thus not distinguished as a broad peak or a sharp peak. As the third peak, the observed peak of the solid¹³ C nucleus NMR was entered, and thus the third peak was distinguished as a broad peak or a sharp peak according to the notation convention of ¹H nucleus NMR. As the convention, Spectrometric Identification of Organic Compounds, 6^{th} edition was referred to.

What is claimed is:

1. A lithium-ion secondary battery comprising:
a positive electrode;
a negative electrode;
a separator present between the positive electrode and the negative electrode; and
an electrolytic solution,
wherein the negative electrode contains silicon or a silicon compound and a binder,
the binder contains polyimide, and
when the negative electrode after discharging is observed by nuclear magnetic resonance (NMR) spectroscopy using a single-pulse magic-angle spinning method (SP-MAS method) and peaks are separated by a Gaussian function, a Lorentzian function or a Voigt function, an NMR spectrum of a solid⁷ Li nucleus has a first peak, and the first peak has a peak top in a chemical shift range of 0.5 ppm or more and 1.5 ppm or less with Li in LiCoO₂ set to −0.5 ppm.

2. The lithium-ion secondary battery according to claim 1,
wherein the NMR spectrum of the solid⁷ Li nucleus further has a second peak, and
the second peak has a peak top at a chemical shift position of 1.6 ppm or more and 3.2 ppm or less with Li in LiCoO₂ set to −0.5 ppm.

3. The lithium-ion secondary battery according to claim 1,
wherein, when the negative electrode after charging and after discharging is observed by nuclear magnetic resonance (NMR) spectroscopy using a cross-polarization magic-angle spinning method (CP-MAS method), MAS NMR spectra of a solid¹³ C nucleus have a third peak, and
the third peak has a peak top in a chemical shift range of 100 ppm or more and 170 ppm or less with a high magnetic field-side peak of an NMR spectrum of hexamethyl benzene set to 16.81 ppm.

4. The lithium-ion secondary battery according to claim 1,
wherein the polyimide is aromatic polyimide.

5. The lithium-ion secondary battery according to claim 2,
wherein the polyimide is aromatic polyimide.

6. The lithium-ion secondary battery according to claim 3,
wherein the polyimide is aromatic polyimide.

7. The lithium-ion secondary battery according to claim 1, wherein the polyimide is a polymer of an acid anhydride and a diamine compound, and both the acid anhydride and the diamine compound each have an aromatic ring.

8. The lithium-ion secondary battery according to claim 1, wherein the polyimide includes a cyclic imide structure and an aromatic compound in a repeating unit of the polyimide.

9. The lithium-ion secondary battery according to claim 8, wherein the cyclic imide structure contains pentacyclic imide.

10. The lithium-ion secondary battery according to claim 1, wherein the silicon compound is a silicon alloy or a silicon oxide.

11. The lithium-ion secondary battery according to claim 1, wherein the negative electrode contains a negative electrode current collector and a negative electrode active material layer comprising a negative electrode active material and the binder, and the negative electrode active material comprises the silicon or the silicon compound.

12. The lithium-ion secondary battery according to claim 11, wherein an amount of the silicon or the silicon compound is 50 mass % or more relative to a total amount of the negative electrode active material.

13. The lithium-ion secondary battery according to claim 11, wherein a specific surface area of the negative electrode active material obtained by a BET method is 0.5 m²/g or more and 100 m²/g or less.

14. The lithium-ion secondary battery according to claim 11, wherein the negative electrode active material is a composite body of the silicon or the silicon compound in which at least some of surfaces of particles of the silicon or the silicon compound are coated with a conductive material.

15. The lithium-ion secondary battery according to claim 11, wherein the negative electrode active material layer further comprises a conductive assistant and a dispersion stabilizer.

16. The lithium-ion secondary battery according to claim 15, wherein a content rate of the binder relative to a total mass of the negative electrode active material, the conductive assistant and the binder is 1 mass % or more and 20 mass % or less.

17. The lithium-ion secondary battery according to claim 15, wherein the conductive assistant comprises one of a carbon powder, carbon nanotubes, a carbon material, a fine metal powder, or a mixture of a carbon material and a fine metal powder or a conductive oxide.

18. The lithium-ion secondary battery according to claim 15, wherein a content rate of the conductive assistant relative to a total mass of the negative electrode active material, the conductive assistant, and the binder is 5 mass % or more and 20 mass % or less, and a BET specific surface area of the conductive assistant is 100 m²/g or more and 200 m²/g or less.

19. The lithium-ion secondary battery according to claim 15, wherein the dispersion stabilizer is polyvinylpyrrolidone.

20. The lithium-ion secondary battery according to claim 11, wherein the polyimide is uniformly dispersed in the negative electrode active material layer.
